(19) United States
(12) Patent Application Publication
(10) Pub. No.: US 2009/0260397 A1
(43) Pub. Date: Oct. 22, 2009

(54) Glass Structure Having Sub-Micron and Nano-Size Bandgap Structures and Method For Producing Same

(76) Inventors: Ivan A. Cornejo, Corning, NY (US); Sasha Marjanovic, Painted Post, NY (US)

Correspondence Address: CORNING INCORPORATED, SP-TI-3-1, CORNING, NY, 14831, US

(21) Appl. No.: 12/402,841

(22) Filed: Mar. 12, 2009

Related U.S. Application Data
(63) Continuation-in-part of application No. 12/148,591, filed on Apr. 21, 2008.

(51) Int. Cl. C03B 19/06

(52) U.S. Cl. 65/17.6

(57) ABSTRACT

A glass structure having sub-micron and nano-size bandgap structures and a method of fabricating the glass structure is provided. A first glass structure having micron-scale features is made and then the first glass structure is drawn into a second glass structure that has sub-micron and nano-sized features that allow the structure to perform as a polarizer for visible and infrared light

### CROSS-REFERENCE To RELATED APPLICATIONS

This application is a Continuation-in-Part and claims the benefit of, and priority to U.S. Nonprovisional patent application Ser. No. 12/148591 filed on Apr. 21, 2008 entitled, “Glass Structure Having Sub-Micron and Nano-Size Bandgap Structures and Method of Producing Same”, the content of which is relied upon and incorporated herein by reference in its entirety.

### BACKGROUND OF THE INVENTION

1. Field of the Invention

The present invention relates to methods for producing sub-micron and nano-size structures, particularly glass structures.

2. Technical Background

Structures that are used as bandgap structures at a millimeter and micron scales have been made by using ceramic materials and various techniques. For example, one method of making such a micron scale structure is to use what is known as rapid prototyping. This technique typically combines a computer-aided design with a layering process to fabricate the structure. A model of the desired structure is electronically sectioned into layers of a predetermined thickness. The layers of the structure are reconstituted by lamination and the original part is reconstructed. The details and complexity of the final shapes depend on the thickness of the individual starting layers. The structure is then subjected to an organic binder burnout process and a final sintering process. There are several patents that describe this process. These include, for example, U.S. Pat. Nos. 5,738,817, and 5,997,795, the disclosures of which are expressly incorporated by reference herein.

### SUMMARY OF THE INVENTION

Disclosed herein is a method of producing sub-micron and nano-size glass structures that include the steps of dispensing a glass mixture one layer at a time to create a predetermined structure, the glass mixture containing glass powder and a binder, removing at least 75% of the binder from the predetermined structure during the binder burnout process, sintering the predetermined structure to create a first glass structure having a predetermined cross sectional area, and drawing the glass structure into a second glass structure, the second glass structure having a cross sectional area at least 10, in some cases at least 50, and in some cases at least 100 times smaller than the predetermined cross sectional area of the first glass structure. Preferably, the dispensing step comprises dispensing multiple layers, each layer deposited one layer at a time, and in some preferred embodiments such deposition can include deposition of more than 10, more preferably more than 20 multiple layers. In some preferred embodiments, the thickness of each layer can be less than 2 mm, more preferably less than 1 mm, and in some embodiments less than 500 microns. In some embodiments, the drawing step can result in the second glass structure having a cross sectional area at least 500 times, and in some cases at least 800 times smaller than the predetermined cross sectional area of the first glass structure. This process thus enables the formation of standing structures having a width, length, or diameter dimension on the order of 10's or 100's of nanometers.

In another aspect, a glass structure for polarizing light is disclosed, the glass structure includes a unitary glass structure and a plurality of openings extending through the unitary glass structure, the openings in the unitary glass structure having a diameter of about 200 nanometers.

Additional features and advantages of the invention will be set forth in the detailed description which follows and, in part, will be readily apparent to those skilled in the art from that description or recognized by practicing the invention as described herein, including the detailed description which follows, the claims, and the appended drawings.

It is to be understood that both the foregoing general description and the following detailed description of the present embodiments of the invention are exemplary and explanatory, and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a front elevational view of a first unitary glass structure according to the present invention; and

FIG. 2 is an enlarged view of a portion of the unitary glass structure of FIG. 1.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

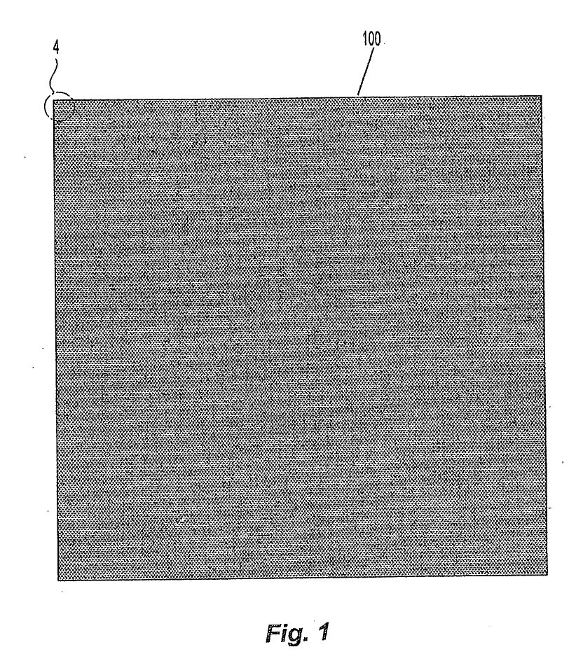

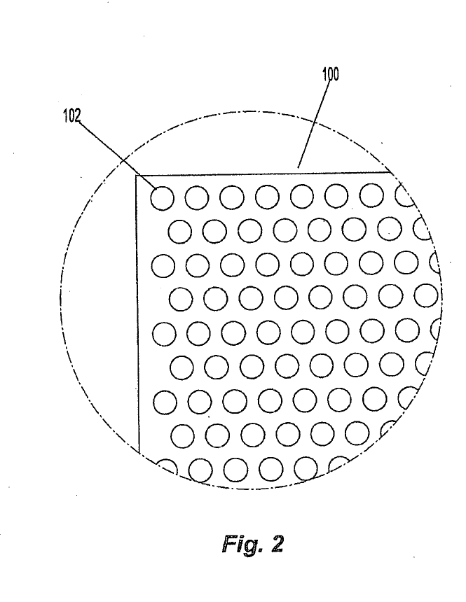

In one embodiment, a glass mixture may be made that can be used to make the predetermined structure 100 illustrated in FIGS. 1 and 2. Such structures can be made using any process capable of depositing or forming structures which have dimensions of several millimeters or less. Preferred deposition techniques include, but are not limited to, microdispensing techniques such as rapid prototyping and micropens. For example, in one embodiment, the predetermined structure 100 may be made using a rapid prototype machine, whereby multiple layers of the glass mixture are “printed”, each layer being printed one at a time, to thereby generate a three dimensional structure. The glass mixture may be any glass composition. For example, in some embodiments the glass mixture may be a silica based glass, e.g., a borosilicate glass. The glass mixture is preferably made with a glass powder of the desired glass composition. Preferably the size of the glass in the glass powder is in the micron range. The glass mixture also preferably includes an organic binder, which may be any appropriate commercially available binder. The glass mixture is preferably 60-90% glass powder and 10-40% binder and more preferably 70-80% glass powder and 20-30% binder. The consistency of the glass mixture is then adjusted to adequately dispense from the rapid prototype machine.

The glass mixture is then dispensed from the machine to form a predetermined structure 100 such as the one illustrated in FIGS. 1 and 2. It should be noted that while the predetermined structure illustrated in FIGS. 1 and 2 is in a square/rectangular configuration, any configuration may be “printed” and fall within the scope of the present invention. It should also be noted that the predetermined structure illustrated in FIGS. 1 and 2 is constructed of a plurality of substructures that are approximately 50 mm×50 mm×2 mm, although the exact dimensions of the substructure or predetermined structure is not vital to the invention. The plurality of the 2 mm thick substructures are fused together to make a longer (or thicker) predetermined structure 100. However, the predetermined structure may also be a single substructure and be within the scope of the present invention. As illustrated in FIGS. 1 and 2, the predetermined structure has holes or openings 102 that are approximately 0.20 mm, but may be of any appropriate size to become 100-1500 nm in the final structure, as noted in more detail below. In fact, the openings, while illustrated as being circular need not be and may be anywhere from about 0.10 mm to about 0.5 mm in diameter. It should be noted that while it is preferably to line up the openings 102 in each of the substructures with the openings 102 in an adjacent substructure prior to fusing to make the longer predetermined structure 100, it is not necessary.

The predetermined structure 100 is then placed into an appropriate oven to burn out the binder and leave only the glass powder in the predetermined structure. The binder is preferably burned out at a temperature which is below the glass transition temperature, T_{g}, to avoid structure deformation and gas entrapment. The sintering process step described below is then preferably done below the glass crystallization temperature, Tₓ, to avoid glass crystallization, which would otherwise potentially hinder the later structure redraw process step. These requirements are more restrictive relative to other materials, e.g. ceramics, metals, metal alloys, etc., where the binder burnout and the sintering process steps could be performed up to the sintering temperature of materials used. Additionally, the binder burn out is preferably carried out in an inert atmosphere, such as, for example, helium, argon, or nitrogen. If the burn out occurs in the presence of oxygen and the glass is for example, a silica based glass, cristobalite may form in the predetermined structure, potentially making it unusable for its intended purposes.

In one preferred embodiment, the burn out schedule starts by heating the predetermined structure from room temperature (or ambient temperature) to 150° C. in one hour. The burn out then continues by heating the predetermined structure from 150° C. to 350° C. at about 10° C./hr and holding the 350° C. temperature for at least one hour. Finally, the predetermined structure is heated from 350° C. to 650° C. at about 10° C./hr and holding the 650° C. temperature for at least one hour.

This burn out schedule will eliminate about 90% of the binder from the predetermined structure. A reduced burnout schedule is possible, but preferably at least 75% of the binder should be removed from the predetermined structure during the binder burnout process step.

The predetermined structure 100 is then sintered to consolidate the glass powder, again preferably in the same oven and in similar inert atmospheric conditions. If the sintering is to occur in a different oven or location, care should be taken with the structure while moving it prior to the sintering step so as not to disturb the construction. During the sintering step, the predetermined structure 100 becomes a first glass structure, which is essentially the same configuration and size of the predetermined structure.

The first glass structure is then heated and drawn or stretched to a reduced diameter as is known in the art, to make a second glass structure that is reduced in cross sectional size relative to the size of the first glass structure. The first glass structure can be heated to a temperature suitable for drawing the first glass structure, and depending on the composition of the glass structure. For example, if the glass is a silicate glass, it is likely that temperatures higher than 1000° C. or even higher than 1100° C. might be employed to draw the glass structure to a reduced diameter. However, lower draw temperatures could also be employed, particularly if the glass is a non-silicate glass composition. In one exemplary embodiment, the first glass structure is drawn to about one thousand times its original length. In drawing the first glass structure, the cross section of the second glass structure can be reduced by more than 100, more than 500, and even more than 800 times smaller than the first glass structure. Thus, for example, in drawing a first glass structure into the second glass structure, the openings in a first glass structure that are 0.2 mm in diameter in the first glass structure become about 200 nm or even less in diameter in the second glass structure and the cross section of the second glass structure becomes about 0.5 mm by 0.5 mm. The use of a differential partial pressure control system is preferably used for maintaining the symmetry of first glass structure through the redraw process. In a differential partial pressure control system, the first glass structure is kept pressurized and the differential partial pressure is controlled through the whole redraw process step. Thus, for example, the holes 102 can be pressurized during the draw process so that they do not collapse during the diameter reduction step.

The elongated second glass structure may then be sectioned to appropriate lengths for the application desired. One exemplary application is as a photonic or phononic bandgap structure that is made of glass with sub-micron and nano-sized features. For example, such structures can be used as a polarizer in the visible or infrared region of the light spectrum. For example, referring to FIG. 2, a structure having holes or openings 102 whose pitch (distance between centers of the holes) is between about 2-300 nm can be used as a photonic polarizer. This structure can be achieved by drawing a first glass structure in which the holes may have a pitch of about 100 microns to 1 mm. In one embodiment, the holes of the starting (first) glass structure has a pitch of about 100 microns, and is drawn to a second glass structure having a 100 nm, equal to a 1000 times diameter reduction. This exemplifies that glass structures having repeating structures therein (e.g. holes) with a pitch less than 500 microns, more preferably less than 250 microns, can be achieved using a diameter reduction less than 3000, more preferably less than 2000, and even more preferably no more than 1000 times from the starting glass structure. As the second glass structure is sectioned, any misalignment of the openings 102 between substructures will be obvious and those sections can be easily discarded.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A method of producing sub-micron or nano-size glass structure comprising the steps of:
dispensing a glass mixture a layer at a time to create a predetermined structure, the glass mixture containing glass powder and a binder;
removing at least 75% of the binder from the predetermined structure during the binder burnout process step;
sintering the predetermined structure to create a first unitary glass structure having a predetermined cross sectional area; and
drawing the unitary glass structure into a second unitary glass structure, the second unitary glass structure having a cross sectional area at least 10 times smaller than the predetermined cross sectional area of the first unitary glass structure.

2. The method of producing sub-micron and nano-size glass bandgap structure according to claim 1, wherein the structure is one of a photonic and a phononic bandgap structure.

3. The method of producing sub-micron and nano-size glass bandgap structure according to claim 1, wherein the structure is photonic polarizer.

4. The method of producing sub-micron and nano-size glass bandgap structure according to claim 1, wherein said removing step comprises removing at least 90% of the binder.

5. The method of producing sub-micron and nano-size glass bandgap structure according to claim 1, wherein the second unitary glass structure has cross sectional area at least 500 times smaller than the predetermined cross sectional area of the first unitary glass structure.

6. The method of producing sub-micron and nano-size glass bandgap structure according to claim 1, wherein the first unitary glass structure has openings about 100-500 microns in diameter.

7. The method of producing sub-micron and nano-size glass bandgap structure according to claim 1, wherein the second unitary glass structure has openings about 50 to 1500 nanometers in diameter.

8. The method of producing sub-micron and nano-size glass bandgap structure according to claim 1, wherein the step of removing the binder and the step of sintering are done in an inert atmosphere.

9. The method of producing sub-micron and nano-size glass bandgap structure according to claim 1, wherein the glass mixture in said dispensing step comprises 60-90% glass powder and 10-40% binder.

10. The method of producing sub-micron and nano-size glass bandgap structure according to claim 1, wherein the glass mixture comprises 70-80% glass powder and 20-30% binder.

11. The method of producing sub-micron and nano-size glass bandgap structure according to claim 1, wherein the step of removing the binder includes the steps of:
heating the predetermined structure from room temperature to 150 degrees;
heating the predetermined structure from 150 degrees to 350 at a predetermined rate and holding the temperature for at least one hour; and
heating the predetermined structure from 350 degrees to 650 degrees at a predetermined rate and holding the temperature for at least one hour.

12. The method of producing sub-micron and nano-size glass bandgap structure according to claim 1, wherein the step of drawing the first unitary structure causes the second unitary glass structure to have a cross sectional area at least 10 times smaller than the first unitary glass structure.

13. The method of producing sub-micron and nano-size glass bandgap structure according to claim 1, wherein the predetermined structure includes a plurality of predetermine substructures, the predetermined substructures being fused together prior to the binder removal step.
